(19) United States
(12) Patent Application Publication
(10) Pub. No.: US 2005/0152366 A1
(43) Pub. Date: Jul. 14, 2005

(54) Delivering cable television over a network agnostic platform

(75) Inventor: Louis E. Heuck, Hilton Head Island, SC (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Hargray Communications

(21) Appl. No.: 10/755,475

(22) Filed: Jan. 13, 2004

(51) Int. Cl. H04L 12/28

(52) U.S. Cl. 370/390; 370/432; 370/464; 370/352

(57) ABSTRACT

Methods and systems consistent with the present invention deliver digital TV service over multiple types of networks. A head end facility receives TV signals and encodes each signal into a respective channel stream. The head end facility then assigns each of the channel streams to a virtual broadcast domain. The head end facility selects a plurality of the channel streams and combines them into an associated stream. The head end facility then transmits the associated stream to one or more local hubs. The local hub receives the associated stream and parses the channel streams from the associated stream. When the subscriber selects a digital TV channel or program for viewing, the local hub then extends the virtual broadcast domain to the subscriber's facility. The subscriber's facility receives the channel stream and then decodes it into a signal that can be displayed by a device.

### DESCRIPTION OF THE INVENTION

1. Field of the Invention

This invention relates generally to providing multiple streams or channels of multimedia data over one or more networks. More particularly, the present invention relates to providing digital television signals over one or more networks.

2. Background of the Invention

Digital television (“TV”) service has grown exponentially in recent years. One reason that digital TV has become popular is that it now includes a variety of features, such as home shopping, premium channels, Internet access, video on demand, and pay per view. As a result, a number of telecommunications companies including cable TV providers, telephone companies, and satellite TV providers have become interested in offering digital TV services. These companies offer their digital TV service using a specific type of broadband network, such as a cable network, satellite network, or digital subscriber line (“DSL”) network.

However, known digital TV service by a particular company is generally limited to one specific type of subscriber connection. For example, a subscriber must have a cable connected to their premises before a cable company can provide digital TV services to that particular subscriber. Unfortunately, implementing connections to wide numbers of subscriber is extremely expensive. As a result, most companies that wish to offer digital TV are often limited to their existing infrastructure. Therefore, even if a particular subscriber can potentially have broadband access that is sufficient to deliver digital TV, many service providers cannot provide their digital TV service to a large number of subscribers unless they can connect to part of their existing infrastructure.

Accordingly, it would be desirable to provide methods and systems that are capable of flexibly delivering digital TV service over a variety of types of networks and infrastructures.

### SUMMARY OF THE INVENTION

In accordance an aspect of the present invention, a method of transmitting multimedia data is provided. A plurality of signals that carry the multimedia data are received and encoded into respective streams. Each of the respective streams is tagged with an identifier that identifies a virtual broadcast domain. A set of the respective streams are then associated into at least one additional stream and the at least one additional stream is transmitted.

In accordance with another aspect of the present invention, a method of delivering multimedia data is provided. A first stream that includes a plurality of second streams is received. Each of the plurality of second streams has a corresponding tag that identifies a virtual broadcast domain. At least one of the second plurality of streams that has been requested by a subscriber is selected. The selected one of the second plurality of streams is then transmitted based on extending the virtual broadcast domain to the subscriber.

In accordance with another aspect of the present invention, a system for providing multimedia data is provided. At least one encoder encodes signals into respective streams each having a unique virtual broadcast domain. A first switch combines a set of the streams into at least one additional stream and transmits the at least one additional stream through a network. A second switch receives the at least one additional stream from the network and extends the virtual broadcast domain of one of the respective streams to subscribers requesting the respective stream.

Additional features of the invention will be set forth in part in the description which follows, and in part will be obvious from the description, or may be learned by practice of the invention. The features of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 illustrates a system in which the present invention may be practiced;

FIG. 2 illustrates a flowchart of the operations used to provide multimedia data over one or more networks in accordance with the present invention; and

FIG. 3 illustrates a flowchart of the operations used to provide multimedia data to the remote end facility in accordance with the present invention.

### DESCRIPTION OF THE EMBODIMENTS

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention.

Methods and systems consistent with the present invention deliver digital TV service over multiple types of networks. A head end facility receives TV signals and encodes each signal into a respective channel stream. The head end facility then assigns each of the channel streams to a virtual broadcast domain, such as a virtual local area network (“VLAN”). The head end facility selects a plurality of the channel streams and combines them into a associated stream. The head end facility then transmits the associated stream to one or more local hubs. Each local hub services one or more subscriber locations, such as a person's home. The local hub receives the associated stream and parses the channel streams from the associated stream. When the subscriber selects a digital TV channel or program for viewing, the local hub then places the subscriber's facility on the virtual broadcast domain, i.e., VLAN that corresponds to the selected channel or program. The subscriber's facility receives the channel stream and then decodes it into a signal that can be displayed by a device, such as a television or computer.

Reference will now be made in detail to the present embodiment, which is illustrated in the accompanying drawings. Wherever possible, the same reference numbers will be used throughout the drawings to refer to the same or like parts.

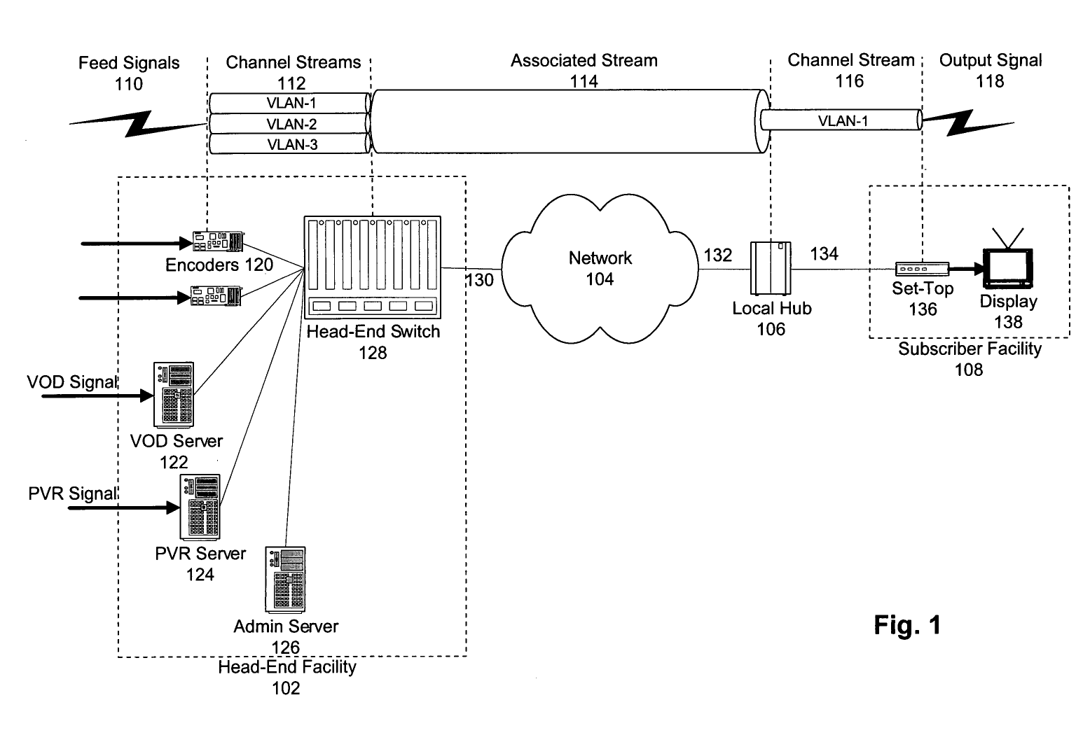

FIG. 1 illustrates a system in which the present invention may be practiced. As shown, system 100 comprises a head end facility 102, a network 104, a local hub 106, and a subscriber facility 108. In general, head end facility 102 receives feed signals 110 and encodes them into channel streams 112. Head end facility 102 assigns each of channel streams 112 to a virtual broadcast domain, such as a VLAN, and tags each of channel streams 112 according to its assigned VLAN. By assigning each of channel streams 112 to a virtual broadcast domain, system 100 is not limited to a particular type of infrastructure (as it would be if using a conventional physical broadcast domain), and thus, may provide channel streams 112 to subscriber facility 108 over a variety of types of networks.

Head end facility 102 selects and associates one or more of channel streams 112 into an associated stream 114. Associated stream 114 is then transmitted through network 104 to local hub 106. Local hub 106 parses channel streams 112 that were combined into associated stream 114 and forwards a channel stream 116 to subscriber facility 108, based on the digital TV channel or program selected by the user. Subscriber facility 108 receives channel stream 116 and decodes it into output signal 118, which is then displayed to a user (not shown).

Channel streams 112 are active at local hub 106, which is closer in proximity to subscriber facility 108 than head-end facility 102. The user can switch between channel streams 112 more quickly with channel streams 112 being active at local hub 106 rather than at head-end facility 102 because channel stream 116 need only be established between local hub 106 and subscriber facility 108. If channel streams 112 were active at head-end facility 102 and not at local hub 106, due to the increased distance, a longer delay may occur between receiving selected channels when channels are switch (i.e., channel surfing), than if channel streams 112 were active at local hub 106.

The specific components and architecture of system 100 will now be described. Head end facility 102 comprises encoders 120, a video on demand server 122, a personal video recording server 124, an administrative server 126, and a head end switch 128. Although FIG. 1 illustrates a single head end facility, system 100 may include multiple head end facilities. The components of head end facility 102 may be coupled together using known types of networks and links. For example, in one embodiment, the components of head end facility 102 may be coupled together using a gigabit Ethernet network. Other types of networks and links may also be used within head end facility 102 in accordance with the principles of the present invention.

Encoders 120 receive feed signals 110 and convert them into channel streams 112. Encoders 120 may be configured to receive a variety of signals, such as analog TV signals and Digital Video Broadcasting Group (“DVB”) signals. In addition, encoders 120 may receive feed signals 110 over a variety of wire line or wireless links. For example, encoders 120 may receive feed signals 110 from a broadcast satellite TV network.

Encoders 120 may encode feed signals 110 at various rates, such as 4-8 Mbps. The encoding rate used by encoders 120 may be varied based on the image and audio quality desired and the types of local access links used by subscriber facility 108. For example, encoders 120 may be configured to encode feed signals 110 at a rate of 4 Mbps to support subscriber facilities that use lower speed broadband connections, such as DSL links. Alternatively, encoders 120 may be configured to encode at higher rates to support subscriber facilities that use higher speed broadband connections, such as optical fiber. Encoders 120 may be implemented using known devices, such as those manufactured by MINERVA Networks.

In addition, encoders 120 encode feed signals 110 into a format that may be carried by a variety of network. For example, in one embodiment, encoders 120 encode feed signals 110 into MPEG-2 streams. The Motion Pictures Coding Experts Group (i.e., MPEG) has developed standards for encoding audio and video. MPEG-2 streams frames of data that encode video and audio for signals, such as digital TV. MPEG-2 streams may be carried within Internet Protocol (“IP”) packets. As a result, MPEG-2 streams may be carried over a wide variety of networks since IP packets can be routed over virtually any type of network or link using what is known as encapsulation. That is, the IP suite of protocols allows an IP packet to be encapsulated within other network protocols, such as asynchronous transfer mode (“ATM”), Ethernet, etc. The principles of the present invention may also use other types of streaming protocols, such as those supported by REAL NETWORKS, APPLE COMPUTER, and IBM.

In order to track each of channel streams 112, encoders 120 may tag (or identify) each of channel streams 112 with an identifier, such as a VLAN identifier. For example, as shown in FIG. 1, channel streams 112 include three channel streams having VLAN-1, VLAN-2, and VLAN-3 as VLAN identifiers. In one embodiment, encoders 120 are each assigned a VLAN by head end switch 128. By assigning each of channel streams 112 to a VLAN, system 100 may dynamically assign any one of channel streams 112 to subscriber 108. Since VLANs specify a logical (rather than a physical) broadcast domain for transmitting packets, system 100 may dynamically determine where each of channel streams 112 are delivered.

Video on demand server 122 provides video-on-demand services (for example, pay-for-view) for system 100. In particular, video on demand server 122 provides one or more channel streams 112 to provide video requested by subscriber facility 108. Video on demand server 122 may be implemented using known hardware and software. In one embodiment, video on demand server 122 provides requested video using MPEG-2 streams that are transmitted through head-end switch 128.

Although video on demand server is shown within head end facility 102, video on demand server 122 may be implemented in other locations other than head end facility 102. For example, you on demand server may be implemented in a location that is coupled to network 104, or within local hub 106.

Personal video recording server 124 provides a personal video recording service for system 100. In particular, personal video recording server 124 may record selected channels or programs that are designated by subscriber facility 108. Personal video recording server 124 may be implemented using known equipment. In one embodiment, personal video recording server 124 records requested a channel or program and encodes it into one of channel streams 112 as an MPEG-2 stream. Upon a request by subscriber facility 108, personal video recording server 124 may provide a recorded channel program. In addition, personal video recording server 124 may be implemented in locations other than head end facility 102, such as a location coupled to network 104 or within local hub 106.

Administrative server 126 tracks billing and provisioning information for system 100. For example, administrative 124 may assist head end switch 128 and control usage of video on demand server 122 and personal video recording server 124 by subscriber facility 108. Administrative server 126 may communicate with subscriber facility 108 to control the services provided by video on demand server 122 and personal video recording server 124. Administrative server 126 may also be implemented in locations other than head end facility 102.

Head end switch 128 receives channel streams 112 from encoders 120 and selects one or more of channel streams 112 to form associated stream 114. Head end switch 128 may determine which of channel streams 112 to include within associated stream 114 based on variety of factors. For example, head end switch 128, may be configured to use a pre-selected set of channel streams 112 for local hub 106.

Alternatively, head end switch 128 may dynamically select one or more of channel streams 112 based on information received from local hub 106. In one embodiment, local hub 106 sends one or more messages, such as an Internet Group Management Protocol (“IGMP”) message, that indicate channels requested by subscriber facility 108 and the other subscriber facility's coupled to local hub 106 (not shown). Based on these messages, head end switch 128 may then select one or more of channel streams 112. In addition, head end switch 128 may periodically notify local hub 106 of all the channel streams that are available.

Head end switch 128 then combines the selected ones of channel streams 112 into associated stream 114. In one embodiment, head end switch 128 utilizes the distance vector multicast routing protocol (“DVMRP”) and the VLAN tag each of channel streams 112 to create associated stream 114. When forming associated stream 114, head end switch 128 may use the statistical multiplexing capabilities of MPEG-2. For example, head end switch 128 may treat channel streams 112 as variable bit rate streams and create associated stream 114 as a constant bit rate stream. Head end switch 128 may then allocate bandwidth dynamically between channel streams 112. That is, as one of channel streams 112 require more bandwidth, head end switch may allocate less bandwidth to those of channel streams 112 that are running at a lower bandwidth.

Head end switch 120 transmits associated stream 114 through network 104. Head end switch 128 may be coupled to network 104 via link 130. Link 130 may be implemented using known structures and protocols. For example, link 130 may be implemented as a synchronous optical network (“SONET”) ring.

Network 104 provides communications infrastructure for coupling head end facility 128 with local hub 106. Network 104 may comprise one or more components and one or more networks. For example, network 104, may be implemented as an asynchronous transfer mode network that utilizes optical carrier (“OC”) type of links, such as OC-48 or higher links. In addition, as noted, network 104 may comprise one or more networks such as a local area network or metropolitan area network.

Local hub 106 serves as a distribution point for delivering and routing the appropriate channel stream to subscriber facility 108. In particular, local hub 106 receives associated stream 114 from head end facility 128 through network 104. Local hub 106 is coupled to network 104 via link 132. Link 132 may be implemented using known structures and protocols, such as SONET rings.

Upon receiving associated stream 114, local hub 106 parses associated stream 114 into channel streams 112. In one embodiment, local hub 106 parses associated stream 114 based on the VLAN tag assigned to channel streams 112. Local hub 106 then determines which channel or program was selected by subscriber facility 108. Local hub 106 may determine which channel or program was selected by subscriber facility 108 based on known protocols and interfaces. For example, local hub facility 106 may communicate with subscriber facility 108 using the known technique of IGMP snooping.

Upon determining a selected channel, local hub 106 dynamically allocates to subscriber facility 108 the VLAN, and thus, the corresponding one of channel streams 112 which encodes the selected program or channel. Local hub 106 then forwards the appropriate one of channel streams 112 as channel stream 116 to subscriber facility 108. For example, as shown in FIG. 1, local hub 106 is forwarding the channel stream having a VLAN identifier of VLAN-1 as channel stream 116.

In order to allow subscriber facility 108 to periodically change between channels or programs (e.g., for “channel surfing”), local hub facility 106 may use dynamic VLANs to change which of channel streams 112 is delivered to subscriber facility 106. For example, local hub 106, may implement a policy-based dynamic VLAN. A policy-based dynamic VLAN is where ports of local hub 106 are dynamically allocated based on a policy enforced by local hub 106. Ports of local hub 106 may be designated as always a member of a VLAN, never a member of a VLAN, or a potential member of a VLAN. When a port is designated as a potential member of a VLAN, and the channel or program corresponding to the VLAN is requested, local hub 106 may dynamically add the port, such as the port corresponding to subscriber facility 108. Based on known techniques of IGMP snooping, local hub 106 may quickly allocate the appropriate VLAN to subscriber facility 108, for example, within 1 second of a user changing channels. Other types of dynamic VLANs may also be used by local hub 106 in accordance with the principles present invention. Local hub 106 may be implemented using known devices, such as those manufactured by NORTEL Networks and CISCO Systems. With known devices, an administrator may switch users between VLANs. Consistent with the invention, however, the user may use known devices to switch the user between VLANs.

Local hub facility 106 then transmits the channel stream, which corresponds to the VLAN of the selected program or channel, i.e., channel stream 116. When transmitting channel stream 116, local hub 106 may be configured to use a variety of interfaces and network protocols to communicate with subscriber facility 108 over link 134. For example, link 134 may be implemented using a variety of broadband technologies, such as satellite links, DSL, cable, or optical fiber. As one example, if link 134 is a cable link, local hub 106 may use the data over cable service interface specification (“DOCSIS”). As another example, if link 134 is a DSL link that uses an ATM interface, local hub 106 may include an appropriate ATM port to transmit channel stream 116 to subscriber facility 108. Similarly, local hub 106 may be configured to accommodate a “fiber to the home” (“FTTH”) link. Accordingly, local hub 106 may accommodate a variety of types of networks and different types of access links to connect to subscriber facility 108.

Subscriber facility 108 comprises a set-top box 136 and a display device 130. Set-top box 136 receives channel stream 116 and converts it into output signal 118. In one embodiment, set-top box 136 includes an MPEG decoder and modulator (not shown). In particular, set-top box 136 may decode channel stream 116 into a digital TV signal. Subsequently, the modulator (not shown) of set-top box 136 may then modulate the digital TV signal into a format that can be used by display device 138. Set-top box 136 may be implemented using known devices such as those manufactured by MINERVA Networks.

Display device 138 receives signal 118 and creates a digital TV picture. Display device 138 may be implemented using known devices such as a television set, or computer. Although shown as separate devices, set-top box 136 and display device 138 may be combined into a single device, such as a personal computer, in accordance with the principles of the present invention.

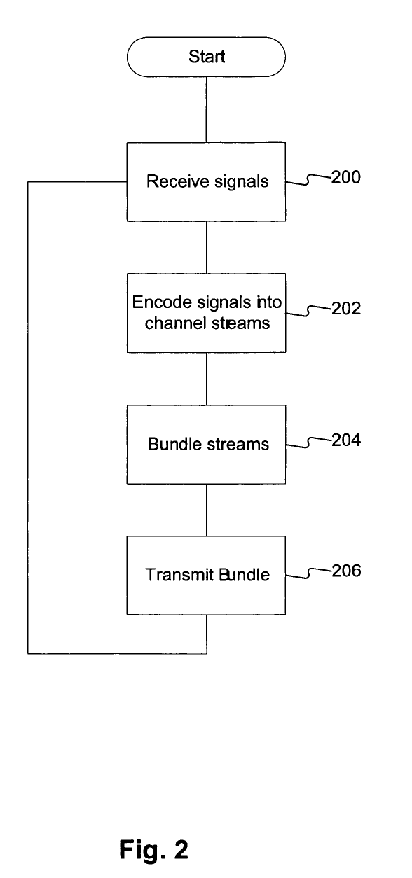

FIG. 2 illustrates a flowchart of the operations used to provide multimedia data over one or more networks in accordance with the present invention. In stage 200, encoders 120 receive feed signals 110.

In stage 202, encoders 120 encode feed signals 110 into respective channel streams 112. In one embodiment, encoders 120 encode feed signals 110 into MPEG-2 streams that are each tagged by a VLAN identifier. In addition, video on demand server 122 and personal video recording server 124 may provide their own channel streams.

In stage 204, head end switch 128 associates one or more of channel streams 112. In particular, head end switch 128 may select a set of channel streams 112 according to a predefined set or based on the channels or programs requested by local hub 106. In one embodiment, head end switch 128 associates a set of channel streams 112 into a MPEG-2 stream, wherein each of the included streams are tagged with a VLAN identifier.

In stage 206, head end switch 128 transmits associated stream 114 through network 104. In one embodiment, head end switch 128 transmit associated stream 114 as a mpeg-2 stream that is encapsulated within IP packets. Processing then returns to stage 200 for continued broadcasting.

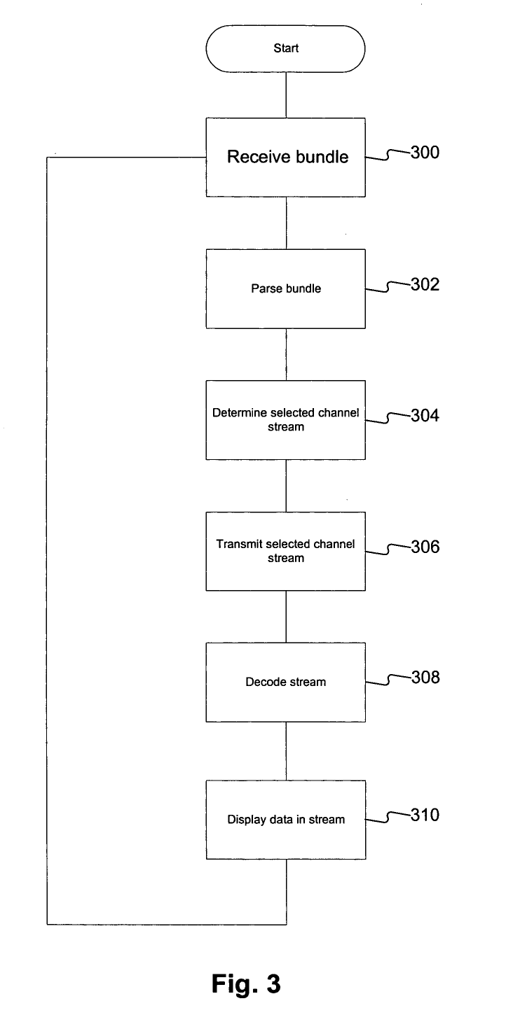

FIG. 3 illustrates a flowchart of the operations used to provide multimedia data to the remote end facility in accordance with the present invention. In stage 300, local hub 106 receives associated stream 114. In one embodiment, local hub 106 receives associated stream in the form of a mpeg-2 stream encapsulated within IP packets.

In stage 302, local hub 106 parses associated stream 114. In particular, local hub 106 identifies each of channel streams 112 included within associated stream 114 based on their respective VLAN identifiers. Local hub 106 may identify each of channel streams 112, for example, based on routing protocol messages advertised through network 104 by head end switch 128. In one embodiment, head end switch 128 may advertise all of the VLAN identifiers for all channels or programs using DVMRP messages.

In stage 304, local hub 106 determines a channel or program selected by subscriber location 108. For example, in one embodiment, local hub 106 periodically conducts IGMP snooping on set-top box 136. When a user selects a particular channel, set-top box 136 will modify its IGMP configuration to indicate the selected channel. In order to ensure that changes are quickly service, local hub 106 may query subscriber location 108 using IGMP snooping frequently, such as every 1 second.

In stage 306, local hub 106 transmits the stream corresponding to the channel or program selected at subscriber facility 108, i.e., channel stream 116, by extending the virtual broadcast domain of the selected channel or program to subscriber facility 108. In one embodiment, local hub 106 dynamically allocates VLANs to ports that are coupled to subscriber 108 using policy-based VLANs. In addition, local hub 106 is configured to transmit channel stream 116 as a mpeg-2 stream that is broadcast over the corresponding VLAN.

In stage 308, subscriber facility 108 receives channel stream 116 and decodes it into output signal 118. In stage 310, display device 138 receives output signal 118 and provides a digital TV signal to the user. Processing then repeats at stage 300.

The foregoing description of possible implementations consistent with the present invention does not represent a comprehensive list of all such implementations or all variations of the implementations described. The description of only some implementation should not be construed as an intent to exclude other implementations. Artisans will understand how to implement the invention in the appended claims in may other ways, using equivalents and alternatives that do not depart from the scope of the following claims. Moreover, unless indicated to the contrary in the preceding description, none of the components described in the implementations is essential to the invention.

1. A method of transmitting multimedia data, comprising:
receiving a plurality of signals that carry the multimedia data;
encoding the plurality of signals into respective streams;
identifying each of the respective streams with an identifier that identifies a virtual broadcast domain;
associating a set of the respective streams into at least one additional stream; and
transmitting the at least one additional stream.

2. The method of claim 1, wherein associating a set of the respective streams into at least one additional stream further comprises associating the set of the respective streams based upon the demand of subscribers associated with an intermediate point.

3. The method of claim 1, further comprising:
receiving the at least one additional stream at an intermediate point; and
transmitting a one of the set of the respective streams to a subscriber facility, the one of the set of the respective streams being selected by a user associated with the subscriber facility.

4. The method of claim 3, wherein the intermediate point comprises a

5. The method of claim 1, wherein receiving the plurality of signals comprises receiving at least one feed signal that is carrying a digital television signal.

6. The method of claim 1, wherein encoding the plurality of signals into respective streams comprises encoding the plurality of signals into a MPEG stream.

7. The method of claim 1, wherein identifying each of the respective streams comprises inserting a tag that identifies a virtual local area network into each of the respective streams.

8. The method of claim 1, wherein associating the set of the respective streams into at least one additional stream comprises statistically multiplexing the respective streams into a single, constant bit rate stream.

9. The method of claim 1, wherein the plurality of signals include at least one of a personal video recording signal and a video on demand signal.

10. A method of delivering multimedia data, comprising:
receiving a first stream that includes a plurality of second streams each having a corresponding tag that identifies a virtual broadcast domain;
identifying each of the second plurality of streams based on their corresponding tags;
selecting at least one of the second plurality of streams that has been requested by a subscriber; and
transmitting the selected one of the second plurality of streams based on extending the virtual broadcast domain to the subscriber based on the subscriber request.

11. The method of claim 10, wherein receiving the first stream comprises receiving a MPEG stream.

12. The method of claim 10, wherein identifying each of the second plurality of streams based on their corresponding tags comprises identifying a virtual local area network assigned to each of the second plurality of streams.

13. The method of claim 10, wherein selecting at least one of the second plurality of streams that has been requested by the subscriber, comprises:
querying the subscriber for a requested stream;
determining a virtual broadcast domain of the requested stream; and
selecting one of the second plurality of streams having a tag that corresponds to the virtual broadcast domain of the requested stream.

14. The method of claim 10, wherein transmitting the selected one of the second plurality of streams based on extending the virtual broadcast domain to the subscriber, comprises:
determining a port that is coupled to the subscriber; and
allocating the port to the virtual broadcast domain of the selected one of the second plurality of streams.

15. An apparatus for transmitting multimedia data, comprising:
means for receiving a plurality of signals that carry the multimedia data;
means for encoding the plurality of signals into respective streams;
means for identifying each of the respective streams with an identifier that identifies a virtual broadcast domain;
means for associating a set of the respective streams into at least one additional stream; and
means for transmitting the at least one additional stream.

16. An apparatus for delivering multimedia data, comprising:
means for receiving a first stream that includes a plurality of second streams each having a corresponding tag that identifies a virtual broadcast domain;
means for identifying each of the second plurality of streams based on their corresponding tags;
means for selecting at least one of the second plurality of streams that has been requested by a subscriber; and
means for transmitting the selected one of the second plurality of streams based on extending the virtual broadcast domain to the subscriber.

17. A system for providing multimedia data, comprising:
at least one encoder for encoding signals into respective streams each having a unique virtual broadcast domain;
a first switch for combining a set of the streams into at least one additional stream and transmitting the at least one additional stream through a network; and
a second switch for receiving the at least one additional stream from the network and extending the virtual broadcast domain of one of the respective streams to subscribers requesting the respective stream.

18. The system of claim 17, wherein the at least one encoder encode the signals into respective MPEG streams.

19. The system of claim 17, wherein the first switch determines the set of streams combined into the at least one additional stream based on information from the subscribers.

20. The system of claim 17, wherein the first switch determines the set of streams combined into the at least one additional stream based on a preselected set of the streams.

21. The system of claim 17, wherein the first switch advertises to the second switch the respective virtual broadcast domains of all of the respective streams.

22. The system of claim 17, wherein the encoders encode the signals into respective streams each having a unique virtual local area network tag.

23. The system of claim 17, wherein the second switch extends the virtual broadcast domain of one of the respective streams based on allocating a virtual local area network to ports corresponding to the subscribers that requested the respective stream.
